(19) United States
(12) Patent Application Publication
(10) Pub. No.: US 2018/0317145 A1
(43) Pub. Date: Nov. 1, 2018

(54) SOURCE AND TARGET NETWORK NODE AND RESPECTIVE METHODS PERFORMED THEREBY FOR PROVIDING MOBILITY TO A WIRELESS DEVICE

(71) Applicant: Telefonaktiebolaget LM Ericsson (publ), Stockholm (SE)

(72) Inventors: Lena Melin, Vaxholm (SE); Anders Christensson, Älvsjö (SE)

(21) Appl. No.: 15/768,478

(22) PCT Filed: Oct. 27, 2015
(86) PCT No.: PCT/SE2015/051135

§ 371 Date: Apr. 13, 2018

(51) Int. Cl. H04W 36/04; H04W 36/14; H04W 36/30; H04W 8/02

(52) U.S. Cl. CPC H04W 36/04; H04W 36/14; H04W 24/10; H04W 8/02; H04W 36/30

(57) ABSTRACT

A source network node and a target network node, as well as respective methods performed thereby, for providing mobility to wireless devices are provided. The source and target network nodes are operable in a wireless communication network. The method performed by the source network node comprises, when an uplink received signal quality from the wireless device does not meet a quality threshold, transmitting scheduling information related to an upcoming uplink transmission of the wireless device to one or more potential target network nodes. The method further comprises obtaining respective uplink signal quality for the respective potential target network node(s), and triggering handover to a target network node if a handover criterion is fulfilled based on the respective uplink signal quality.

### TECHNICAL FIELD

The present disclosure relates to wireless communication and in particular to providing mobility to wireless devices in a wireless communication network.

### BACKGROUND

A wireless communication network generally comprises a plurality of network nodes which support a radio access network of the wireless communication network. Wireless devices may move around within the wireless communication network, wherein the wireless devices need to be handed over from a serving network node to a target network node.

When a wireless device is to be handed over from a serving network node, also referred to as a source network node, to a target network node, different measurements are performed in order to ascertain that the target network node is a good candidate for serving the wireless device.

In e.g. Long Term Evolution, LTE, based communication networks, a serving network node receives measurement reports from wireless device(s) indicating the quality of the downlink channel between the serving network node and the wireless device(s). The measurement reports also indicate how well the wireless device can hear other network nodes, i.e. an indication of the quality of a downlink channel between the wireless device and the other network nodes.

The radio link quality is vital for the quality of the connection between the wireless device and the serving network node. If the radio link quality is degraded the throughput degenerates or the call might be dropped. Mobility mechanisms need to measure and supervise the radio link quality and assure that the wireless device is connected to the best cell of the serving network node, or at least a good enough cell of the serving network node.

It might be that the uplink and downlink are not balanced meaning that a channel may be good in one direction, but bad in the opposite direction. E.g. the downlink may be good but the uplink is poor. If so, there is an increased risk of the call being dropped or at least providing a poor performance. In order to attempt to ensure that a wireless device is not handed over to a target network node having such conditions, the source network node may set a higher quality margin on the downlink, meaning that the measured downlink quality needs to be higher than perhaps necessary in order to take height for a possible downlink-uplink imbalance. This may lead to under-utilisations of some cells or network nodes and possibly also unnecessary handovers.

### SUMMARY

The object is to obviate at least some of the problems outlined above. In particular, it is an object to provide a source network node, a target network node and respective methods performed thereby for providing mobility to a wireless device. These objects and others may be obtained by providing a source network node and a target network node and a method performed by a source network node and a target network node according to the independent claims attached below.

According to an aspect a method performed by a source network node serving a wireless device in a wireless communication network for providing mobility to the wireless device is provided. The method comprises, when an uplink received signal quality from the wireless device does not meet a quality threshold, transmitting scheduling information related to an upcoming uplink transmission of the wireless device to one or more potential target network nodes. The method further comprises obtaining respective uplink signal quality for the respective potential target network node(s); and triggering handover to a target network node if a handover criterion is fulfilled based on the respective uplink signal quality.

According to an aspect a method performed by a target network node serving a wireless device in a wireless communication network for providing mobility to the wireless device is provided. The method comprises receiving scheduling information related to an upcoming uplink transmission of the wireless device from source network node; and measuring received uplink quality for the scheduled transmission. The method further comprises transmitting a measurement report to source network node.

According to an aspect a source network node serving a wireless device in a wireless communication network for providing mobility to the wireless device is provided. The source network node is configured for, when an uplink received signal quality from the wireless device does not meet a quality threshold, transmitting scheduling information related to an upcoming uplink transmission of the wireless device to one or more potential target network nodes. The source network node is further configured for obtaining respective uplink signal quality for the respective potential target network node(s); and triggering handover to a target network node if a handover criterion is fulfilled based on the respective uplink signal quality.

According to an aspect a target network node serving a wireless device in a wireless communication network for providing mobility to the wireless device is provided. The target network node is configured for receiving scheduling information related to an upcoming uplink transmission of the wireless device from source network node; and measuring received uplink quality for the scheduled transmission. The target network node is further configured for transmitting a measurement report to source network node.

The method performed by the source network node, the method performed by the target network node, the source network node and the target network node may have several advantages. One possible advantage is that both the uplink and downlink situation, or characteristics, may be taken into account when determining whether to hand over the wireless device or not. Another possible advantage is that handover oscillations may be prevented since the risk of the uplink being too poor after handover may be minimised or eliminated. Still a possible advantage is that less number of calls may be dropped, again due to minimalizing or eliminating the risk of having a poor uplink after handover. Yet a possible advantage is that a better throughput may be obtained. A further possible advantage is that less handover failures may be achieved.

### BRIEF DESCRIPTION OF DRAWINGS

Embodiments will now be described in more detail in relation to the accompanying drawings, in which:

FIG. 1a is a flowchart of a method performed by a source network node for providing mobility to a wireless device according to an exemplifying embodiment.

FIG. 1b is a flowchart of a method performed by a source network node for providing mobility to a wireless device according to another exemplifying embodiment.

FIG. 1c is a flowchart of a method performed by a source network node for providing mobility to a wireless device according to yet an exemplifying embodiment

FIG. 2 is a flowchart of a method performed by a target network node for providing mobility to a wireless device according to an exemplifying embodiment.

FIG. 3a is a schematic illustration of an example in which two network nodes have overlapping cell edges.

FIG. 3b is a schematic illustration of an example in which a network node has two cells, or cell layers, on different frequencies.

FIG. 3c is a flowchart of a method performed by a serving network node for providing mobility to a wireless device according to an exemplifying embodiment.

FIG. 3d is a signalling diagram in an example of uplink quality measurements in a potential target network node.

FIG. 4 is a block diagram of a source network node for providing mobility to a wireless device according to an exemplifying embodiment.

FIG. 5 is a block diagram of a source network node for providing mobility to a wireless device according to another exemplifying embodiment.

FIG. 6 is a block diagram of a target network node for providing mobility to a wireless device according to an exemplifying embodiment.

FIG. 7 is a block diagram of a target network node for providing mobility to a wireless device according to another exemplifying embodiment.

FIG. 8 is a block diagram of an arrangement in a source network node for providing mobility to a wireless device according to an exemplifying embodiment.

FIG. 9 is a block diagram of an arrangement in a target network node for providing mobility to a wireless device according to an exemplifying embodiment.

### DETAILED DESCRIPTION

Briefly described, a source network node and a target network node, as well as respective methods performed thereby, for providing mobility to wireless devices are provided. The source network node detects that an uplink signal quality is poor for a wireless device and initiates a handover procedure. The handover procedure comprises potential target network nodes measuring uplink received signal quality associated with the wireless device. Once the source network node has obtained information about the respective uplink channel conditions or characteristics of potential target network nodes, the source network node may determine to either keep serving the wireless device or handing over the wireless device to one of the potential target network nodes based on uplink channel conditions or characteristics of itself and potential target network nodes with regard to the wireless device, and/or downlink channel conditions or characteristics of itself and potential target network nodes.

In this disclose the terms network node and wireless device are used. Examples of a network node are a base station, NodeB (NB), evolved NodeB (eNB), base station controller, radio network controller, and access point. Examples of a wireless device are a mobile terminal, mobile phone, smartphone, laptop, personal digital assistant, user equipment (UE), vehicle or other device comprising or being connected to a communication arrangement providing means for the vehicle or other device to communicate with network nodes of a wireless communication network.

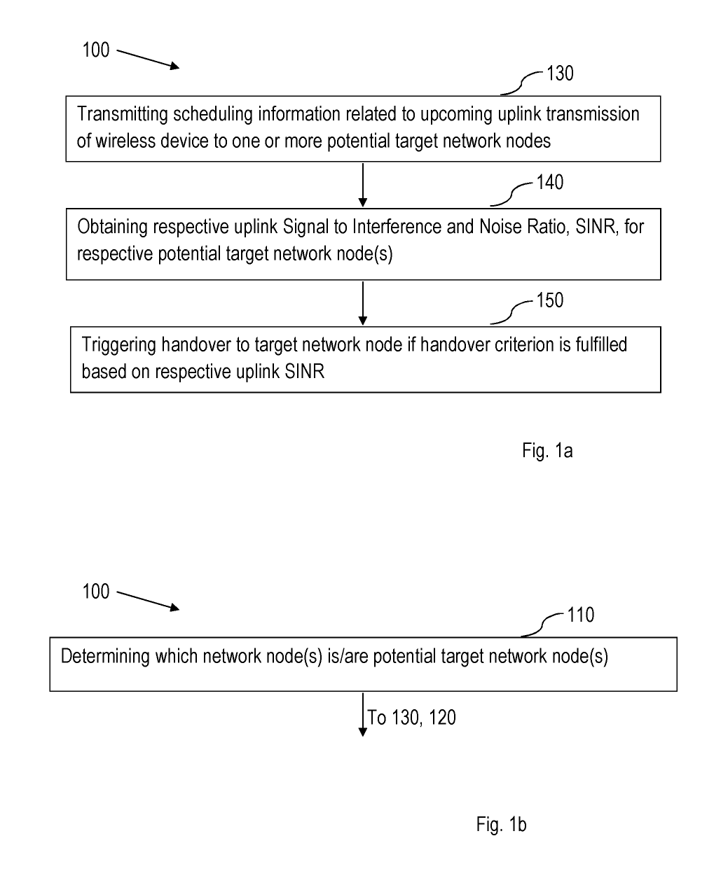

Embodiments herein relate to a method performed by a source network node serving a wireless device in a wireless communication network for providing mobility to the wireless device. Embodiments of such a method will now be described with reference to FIGS. 1a-1c.

FIG. 1a illustrates the method 100 comprising, when an uplink received signal quality from the wireless device does not meet a quality threshold, transmitting 130 scheduling information related to an upcoming uplink transmission of the wireless device to one or more potential target network nodes. The method further comprises obtaining 140 respective uplink signal quality for the respective potential target network node(s); and triggering 150 handover to a target network node if a handover criterion is fulfilled based on the respective uplink signal quality.

The source network node may continuously, regularly, or randomly monitor the uplink received signal quality. The source network node may receive one or more uplink transmissions from the wireless device, wherein the uplink transmission may comprise both reference signals and data signals. There are different ways of determining the received uplink signal strength as will be described in more detail below. Since the wireless device generally is moveable meaning that it may move about and roam within the wireless communication network, the wireless device may reach a position in which the uplink signal quality becomes relatively poor. By measuring the received uplink signal quality, the source network node may determine if the received uplink signal quality is poor enough to not meet the quality threshold. As this happens, the source network node may consider handing over the wireless device to a target network node. Depending on where the wireless device is located, there may be one or more different potential target network nodes to which the wireless device may be handed over to. It will be described in more detail below how the source network node determines which network nodes may be suitable and thus be potential target network nodes.

The source network node receives measurement reports from the wireless device indicating downlink signal quality from one or more potential target network nodes. However, even if the downlink signal quality is satisfactorily strong for a potential target network node to be a promising source network node after handover, the uplink signal quality towards that network node may prove to be too poor for the potential target network node to be an appropriate source network node after handover. Thus, in order for the source network node to obtain more information to found its decision on, it requires uplink signal quality measures for the potential target network nodes. In order for the potential network node(s) to be able to measure received uplink signal quality, it/they need to know when the wireless device is to perform an uplink transmission. Thus, the source network node transmits scheduling information related to an upcoming uplink transmission of the wireless device to one or more potential target network nodes. In this manner, that or those potential target network nodes may perform measurements on the upcoming uplink transmission of the wireless device.

The wireless device will perform the uplink transmission to the source network node, which uplink transmission may also be received by the one or more potential network nodes, wherein they may perform measurements of the signal quality of the received uplink signal. Once the potential target network node(s) has performed these measurements, it/they may inform the source network node about the measurements. The source network node thus obtains respective uplink signal quality for the respective potential target network node(s).

The source network node may thus compare the respective uplink signal quality for the respective potential target network node(s) to the handover criterion to see how well the respective uplink signal quality fulfils the handover criterion. The source network node may then trigger a handover to a target network node if the handover criterion is fulfilled based on the respective uplink signal quality.

The method may be implemented such that the method is performed in a communication network for providing mobility to a wireless device, the method comprising, e.g. in a handover unit of a network node, when an uplink received signal quality from the wireless device in the source network node does not meet a quality threshold, triggering 130 transmission of scheduling information related to an upcoming uplink transmission of the wireless device to one or more potential target network nodes, and triggering 160 handover from the source network node to a target network node when an evaluation of obtained respective signal quality of the respective potential target network nodes against one or more criteria fulfils a handover criterion.

In this alternative implementation, the handover unit may be comprised in the source network node, or in a network node of a so-called cloud, wherein some functionality is transferred to the network node of the cloud. Thus, when the source network node receives the uplink signal from the wireless device, either the source network node or the node of the cloud may determine the uplink received signal quality. Then the network node of the cloud may trigger the transmission of scheduling information related to an upcoming uplink transmission of the wireless device to one or more potential target network nodes, e.g. by means of the handover unit. The source network node may then transmit scheduling information related to an upcoming uplink transmission of the wireless device to one or more potential target network nodes when being triggered by the network node of the cloud. Once the handover unit has obtained respective uplink signal quality for the respective potential target network node(s); the handover unit may trigger handover from the source network node to a target network node when an evaluation of obtained respective signal quality of the respective potential target network nodes against one or more criteria fulfils a handover criterion.

Generally, a coverage area of a network node is referred to as a cell. A network node may have more than one cell, wherein each cell may have different cell identities. A wireless device is served by, or is connected to, the source network node by means of a cell of the source network node, or serving network node. This cell may also be referred to as a source or serving cell. Since the source network node may have a plurality of cells, it might be that the target network node is the same physical node as the source network node, but that the target network node is represented by a different cell of the source network node, which may also be referred to as a target cell. Thus, when the wireless device is “handed over” from a “source cell” to a “target cell”, the target cell may be a cell of a physically different network node, or be a cell the same physical network node as the source cell.

The method performed by the source network node may have several advantages. One possible advantage is that both the uplink and downlink situation, or characteristics, may be taken into account when determining whether to hand over the wireless device or not. Another possible advantage is that handover oscillations may be prevented since the risk of the uplink being too poor after handover may be minimised or eliminated. Still a possible advantage is that less number of calls may be dropped, again due to minimalizing or eliminating the risk of having a poor uplink after handover. Yet a possible advantage is that a better throughput may be obtained. A further possible advantage is that less handover failures may be achieved.

The handover criteria may comprise one or more of (i) a relationship between uplink signal quality for the source network node and respective uplink signal quality for the respective potential target network node(s); (ii) relationship between uplink signal quality for the target network node and a target signal quality threshold; and (iii) a relationship between a downlink signal quality for the source network node and respective downlink signal quality for the respective potential target network node(s).

When the source network node determines whether to keep the wireless device or to hand it over to one of the potential target network nodes, the source network node may look at one or more criteria making up the handover criterion. One example is to compare the uplink signal quality for the source network node and respective uplink signal quality for the respective potential target network node(s). In one very simple example, the source network node may simply choose to handover the wireless device to the potential target device having the strongest or best uplink channel quality, if it is better than the uplink signal quality for the source network node.

In another example, the source network node may additionally take the quality threshold into account when looking at the uplink signal quality for the source network node and respective uplink signal quality for the respective potential target network node(s). Merely as an example, the handover criterion may be that not only must the uplink signal quality of a potential target network node be better than the uplink signal quality of the serving network node, but also the uplink signal quality of the potential target network node must meet the quality threshold in order for the handover criterion to be fulfilled.

In yet another example, the source network node may look at the relationship between a downlink signal quality for the source network node and respective downlink signal quality for the respective potential target network node(s). In addition, the source network node may also look at the relationship between uplink signal quality for the source network node and respective uplink signal quality for the respective potential target network node(s), thus combining characteristics of uplink and downlink signal quality in order to determine if the handover criterion is met.

The signal quality may be determined or represented by one or more of Signal to Interference and Noise Ratio, SINR, Received Power Spectral Density, RPSD, Reference Signal Received Quality, RSRQ, Reference Signal Received Power, RSRP, and Received Signal Strength Indicator, RSSI.

There are different manners, or ways, to determine signal quality, both uplink received signal quality and downlink received signal quality. The source network node may measure received signal strength of a received uplink signal based on either data or reference signals, or both, that are received in the uplink signal.

SINR is a quantity which may also be used to give theoretical upper bounds on channel capacity (or the rate of information transfer) in wireless communication systems such as networks. SINR may be defined as the power of a certain signal of interest divided by the sum of the interference power (from all the other interfering signals) and the power of some background noise.

RPSD may be used as a measure of the strength of variations of energy as a function of frequency. In other words, it shows at which frequencies variations are strong and at which frequencies variations are weak. The unit of PSD is energy per frequency (width) and it is possible to obtain energy within a specific frequency range by integrating PSD within that frequency range. Computation of PSD may be done directly by a method called Fast Fourier Transform, FFT, or computing an autocorrelation function and then transforming it.

RSRQ indicates quality of received reference signal. RSRQ measurement and calculation may be based on RSRP and RSSI since RSRP may determine signal quality and RSSI may determine co-channel interference and noise.

RSRP is a linear average of downlink reference signals across the channel bandwidth and it may provide information about signal strength.

RSSI represents the total received wide-band power by the wireless device and is measured only in symbols containing reference signals. RSSI includes power from serving cell as well as co-channel interference and noise.

In an example, the obtaining of the respective signal quality, e.g. SINR, for the respective potential target network node(s) comprises receiving the respective signal quality, e.g. SINR, from the respective potential target network nodes.

The uplink signal quality may be measured and/or determined by the respective potential target network node(s). The respective potential target network node(s) may perform different calculations such as determining e.g. SINR and then send the result to the source network node.

The respective potential target network node(s) may determine e.g. the SINR based on measurements performed by the respective potential target network node(s) on the received uplink signal from the wireless device, as received according to the scheduling information that the source network node previously sent to the respective potential target network node(s).

In another example, the obtaining of the respective signal quality, i.e. SINR, for the respective potential target network node(s) comprises receiving measured received signal strength and interference plus noise from the respective potential target network node(s) and determining the respective SINR for the respective potential target network node(s) based on the received measured received signal strength and interference plus noise from the respective potential target network nodes.

This is another example in which the source network node may only receive so-called raw data, e.g. the measurement result from the respective potential target network node(s). The respective measurement result from the potential target network node(s) may comprise information pertaining to measured received signal strength and interference plus noise.

If this is the case, the source network node should determine the respective signal quality, in this case the SINR, based on the received measured received signal strength and interference plus noise from the respective potential target network nodes. Once the source network node has determined, or received, the respective SINR relating to the respective potential target network node(s) and the SINR relating to itself, the source network node may compare e.g. its own SINR to the respective SINR of the respective potential target network node(s) in order to determine whether or not to trigger a handover of the wireless device to one of the potential target network nodes if the relationship in-between the SINRs fulfil the handover criterion (or parts of the handover criterion). The source network node may take other factors into account making up the handover criterion as describe above.

The method may further comprise determining 110 which network node(s) is/are potential target network node(s).

In order for the source network node to know which network node(s) to send the scheduling information to, the source network node may determine which network node(s) is/are potential target network node(s). This may be done in different ways as will be explained directly below.

Once the source network node has determined which network node(s) is/are potential target network node(s), the source network node may proceed and send to it/them the scheduling information of the wireless device so that the potential network node(s) may receive the uplink transmission from the wireless device and perform the appropriate measurements in order to determine received uplink signal quality.

In an example, the determining of 110 which network node(s) is/are potential target network node(s) comprises one of (a) obtaining the potential network node(s) from a database or memory, or (b) receiving a measurement report from the wireless device indicating respective signal strength of neighbouring network nodes and determining the potential target network node(s) based on the received measurement report.

There may be a plurality of neighbouring network nodes that may be potential target network nodes. The neighbouring network nodes may be rather constant or they may change, e.g. by means of low power network nodes such as home network nodes being added and removed rather randomly. There may be e.g. a database stored either in the source network itself which it may itself keep up to date, or the database may be stored in another node with which the source network node may communicate.

Alternatively, the source network node may receive measurement report(s) from the wireless device indicating which other network node(s) the wireless device is able to hear, i.e. receive reference signals from. The measurement report may comprise information on signal quality of the network node(s) the wireless device is able to hear, wherein the source network node may select all or some of them as potential target network nodes. The network node may e.g. select the network node(s) being associated with the strongest received signal strength or the network node(s) being associated with a received signal strength meeting a predefined threshold.

The method 100 may further comprise transmitting 120 information to the wireless device indicating which frequency carriers to transmit at least DeModulation References Signals, DMRSs, on.

There are two different types of handover, intra frequency and inter frequency. The intra frequency, IAF, handover relates to handovers wherein the wireless device is handed over to a target network node employing the same frequency as the source network node. The inter frequency, IEF, handover relates to handovers wherein the wireless device is handed over to a target network node employing a different frequency as the source network node. The IEF may also comprise an inter Radio Access Technology, inter RAT, handover.

The IAF handover procedure may comprise: the wireless device being configured with IAF measurements continuously measures and compares the downlink quality of the serving (i.e. source) and neighbour network nodes (i.e. potential targets), or cells. When quality event thresholds (optionally also plus hysteresis and possible offsets) are fulfilled during time-to-trigger seconds the wireless device may send a measurement report to the serving/source network node. The eNB evaluates events and decides whether to initiate IAF handover

When the quality of serving and neighbour IAF network node(s), or cell(s), is/are below some quality thresholds the wireless device is generally requested to start IEF (or inter-RAT) measurements on one or a few frequency carriers. Generally in IEF handovers, the wireless device sends a measurement report when it has detected a cell of a target network node with good enough downlink quality and the serving/source network node evaluates the measurement report and decides whether to initiate IEF handover. Generally only the best reported cell is considered for handover (which does not necessarily mean that this is the best possible cell).

In order for the wireless device to know which frequency carriers to transmit on, the source network node transmits information to the wireless device indicating which frequency carriers to transmit at least DeModulation References Signals, DMRSs, on. The wireless device may transmit the same uplink signal on all frequency carriers, the same uplink signal being the uplink signal intended for the source network node, the uplink signal being sent on all frequency carriers as indicated by the source network node. However, the wireless device may not need to send the same uplink signal on all frequency carriers since the potential target network nodes only need reference signal(s) or symbols to perform received uplink signal quality measurements. Consequently, it is enough that the wireless device only transmits reference signals/symbols, such as DMRSs, on those frequency carriers as indicated by the source network node; and only sends the uplink signal possible comprising data and other information to the source network node.

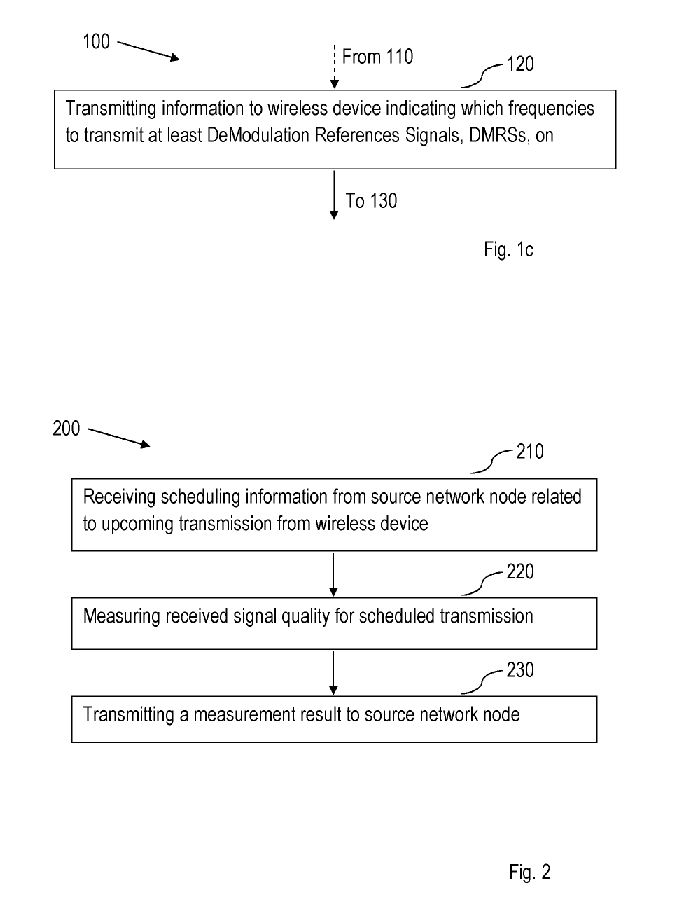

Embodiments herein also relate to a method performed by a target network node for providing mobility to the wireless device. Embodiments of such a method will now be described with reference to FIG. 2.

FIG. 2 illustrates the method comprising receiving 210 scheduling information related to an upcoming uplink transmission of the wireless device from source network node; and measuring 220 received uplink quality for the scheduled transmission. The method further comprises transmitting 230 a measurement report to source network node.

In order for the target network node to perform the required measurements on received uplink signal quality, both for IEF and IAF handover, the target network node needs to know when the wireless device will send the uplink signal so that the target network node may receive it and perform the corresponding measurements. The target network node may also be informed about which frequencies that the wireless device will transmit on, thus that information may be included in the scheduling information related to the upcoming uplink transmission of the wireless device.

It shall be observed again that the wireless device is connected to the source network node by means of a cell thereof, the source cell. The target cell, i.e. the cell of the target network node may be a cell of the same physical network node as the source network node, or a cell of a different physical network node than the source network node.

Once the target network node has received the scheduling information for the upcoming uplink transmission, the target network node may properly receive the uplink transmission as the transmission occurs and measure the received uplink quality.

The target network node then transmits a measurement report to the source network node with the result of the performed measurement. In this manner, the source network node is provided with information regarding the uplink signal quality between the wireless device and the target network node and may then evaluate the uplink signal quality between the wireless device and the target network node as well as the uplink signal quality between the wireless device and the source network node, as described in detail above.

The method performed by the target network node may have the same advantages as the method performed by the source network node as they cooperate in providing mobility to the wireless device. One possible advantage is that both the uplink and downlink situation, or characteristics, may be taken into account when determining whether to hand over the wireless device or not. Another possible advantage is that handover oscillations may be prevented since the risk of the uplink being too poor after handover may be minimised or eliminated. Still a possible advantage is that less number of calls may be dropped, again due to minimalizing or eliminating the risk of having a poor uplink after handover. Yet a possible advantage is that a better throughput may be obtained. A further possible advantage is that less handover failures may be achieved.

In an example, the measuring 220 of the received uplink quality for the scheduled transmission comprises receiving the uplink transmission from the wireless device.

The target network node may, having received the scheduling information from the source network node, receive the uplink transmission from the wireless device.

The target network node knows when and on which frequency carrier(s) the wireless device will transmit the uplink signal and may thus properly receive it in order to perform the required measurement(s) on it.

In yet an example, the measurement report comprises (i) an uplink SINR, which is determined based on the measuring 220 of the received uplink quality for the scheduled transmission; or (ii) a measured received signal strength and noise plus interference of the target network node

When the target network node performs the measurement(s) on the received uplink signal, such as received signal strength, power, and/or quality, the target network node may perform different calculations based on the measured value(s). One example is to determine the SINR.

The target network node may include in the measurement report either the raw measured values so that the source network node may perform the necessary calculations, such as e.g. determining the SINR for the target network node; or the target network node may perform those calculations and e.g. determine the SINR for the target network and send the result to the source network node.

Generally, in LTE, for wireless devices in RRC_CONNECTED mode the mobility decisions are taken by the network node. Input to these decisions is radio link quality measurements done by the wireless devices and the result are reported to the network node in event based RRC Measurement Reports. The wireless devices measure the downlink radio signal quantities RSRP and/or

RSRQ. Quality measurements and Radio Resource Control, RRC, reporting procedures are standardised by 3^{rd} Generation Partnership Project, 3GPP.

Even in good radio coverage an IEF handover might be triggered in case the load-situation is uneven and the wireless device is expected to get better throughput if connected to another cell.

Both the IAF handover and the IEF handover are normally based on downlink quality. If the uplink conditions between cells are roughly the same (no cell is disturbed significantly more in uplink than another cell) and the cell sizes are the same on one frequency layer, the downlink only method is typically enough for appropriate handover decisions.

Existing radio link quality evaluation and decision making for mobility does not take uplink conditions on the serving cell (i.e. the cell of the serving network node by means of which the wireless device is connected to the serving network node) into account. Moreover, the existing mechanism does not take into account the uplink conditions on a potential target cell (i.e. the cell of the target network node by means of which the wireless device is connected to the target network node) when making decisions on whether to perform handover or not, i.e. the mobility decisions relies on measurements and evaluations of the downlink quality only but relying on downlink quality only may not be enough. Uplink problems may be static and possible to solve to some extent with good network planning. But uplink problems may also be dynamic and vary due to load fluctuations.

If uplink and downlink are not balanced, but only the downlink is considered in mobility decisions this may lead to
Bad uplink quality in the serving cell may lead to slower throughput. Bad uplink quality will not trigger searching for a better cell—even if there is one. Bad uplink quality means if the uplink quality degrades before the downlink quality there might be a drop during handover.
Not considering the uplink quality in the potential target cells means that a handover might be triggered to a cell with the same, or even worse, uplink quality.
The only available tool for the operator, that fears drops due to uplink problems, is to set a higher quality margin on the downlink. This may partially work, but it also leads to under-utilisations of some cells, and possibly unnecessary handovers.

In order to be able to move the wireless to a cell, where the uplink problem is solved, the uplink situation on the potential target cell of a corresponding potential network node needs to be known. A potential target network node has difficulties to measure on the wireless device's uplink transmission(s) since the uplink transmissions are scheduled by the source cell scheduler.

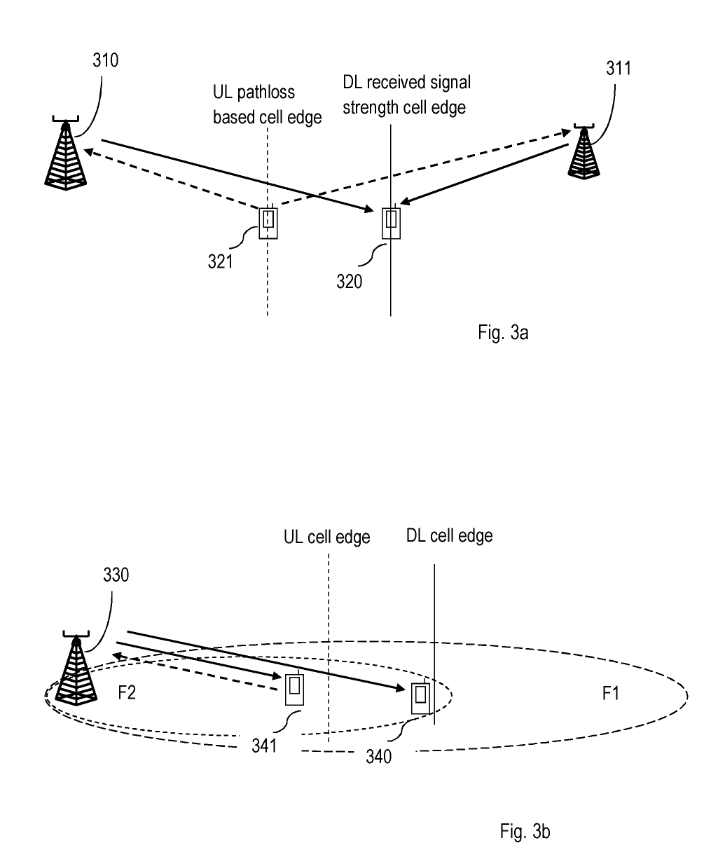

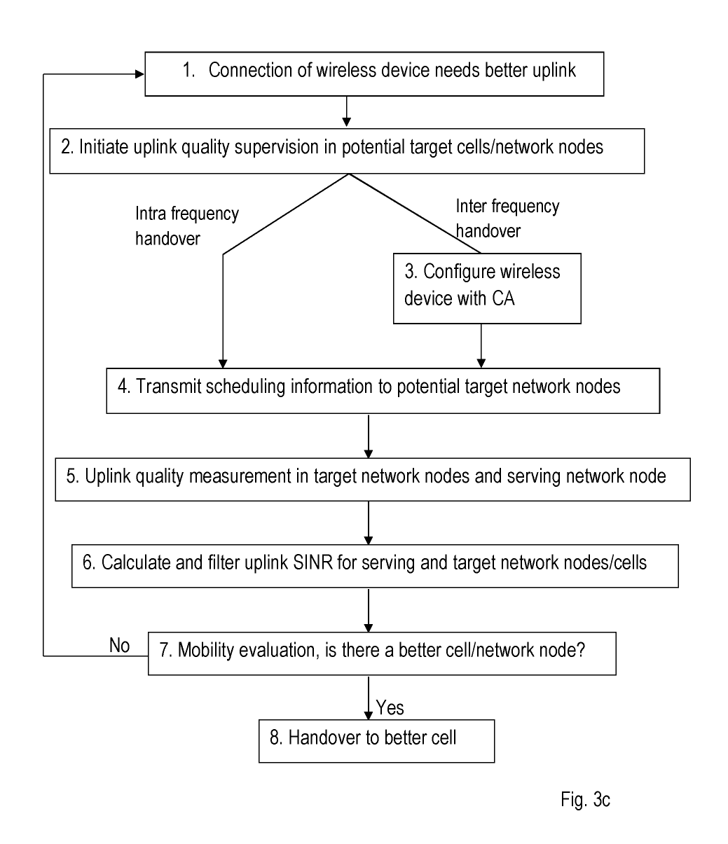

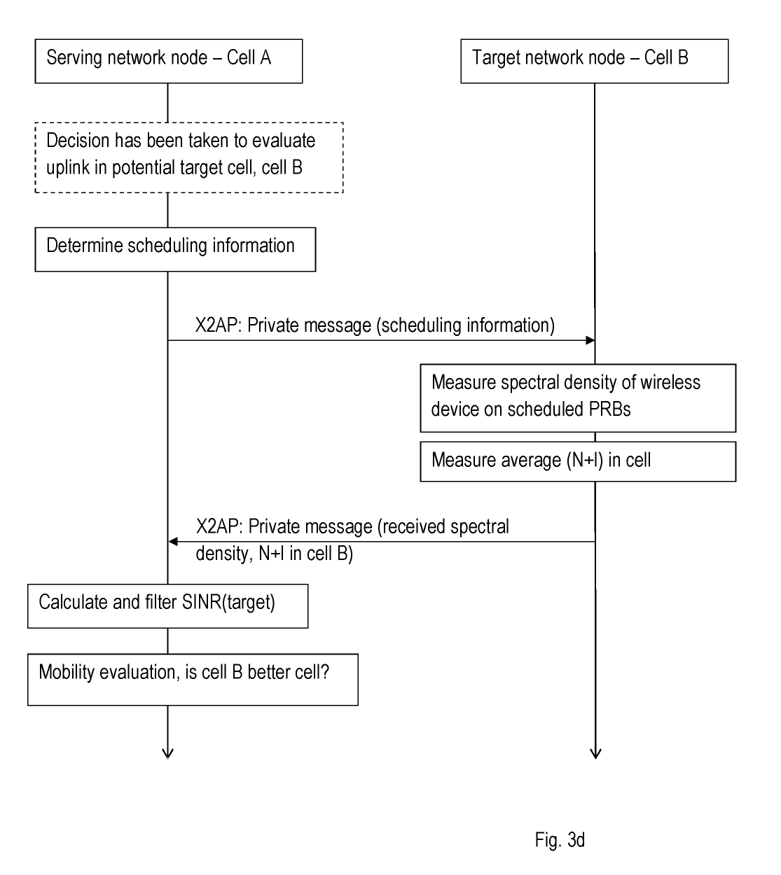

FIG. 3a is a schematic illustration of an example in which two network nodes 310 and 311 have overlapping cell edges. In this specific example, network node 310 may be a macro network node and network node 311 may be a low power network node. In such situations, the cell of the low power network node 311 may provide a better uplink relative to the cell of the macro network node 310, while at the same time, the cell of the low power network node 311 may add interference in the cell of the macro network node 310. In this example, using uplink limit as cell edge, wireless devices connected to the low power network node create interference in the macro network node, and using downlink limit as cell edge, wireless devices connected to the macro network node create uplink interference in the low power network node.

FIG. 3b is a schematic illustration of an example in which a network node has two cells, or cell layers, on different frequencies. The different cells are associated with different path loss. Cell F1 is associated with a frequency 700 MHz and cell F2 is associated with a frequency 2600 MHz. This results in a scattered coverage in F2 and a problematic cell edge. Uplink-downlink cell edges are not in balance. The uplink-downlink cell edge depends on uplink-downlink link budgets—and is therefore service dependent. In Time Division Duplex, TDD, there is a dependency on sub-frame allocation etc.

By the methods described above, the signal quality of the uplink data transmission on e.g. Physical Uplink Shared Channel, PUSCH, may be estimated by using e.g. the received power spectral density of e.g. the DMRS. Received Noise and Interference level in the cell may be measured. An uplink SINR value may then be calculated. The uplink SINR is a good quality measure for the uplink radio connection.

In an exemplifying embodiment, the uplink of the serving cell is supervised and of the serving cell is supervised and UL SINR is calculated. The proposed solution utilises the uplink channel quality supervision mechanism provided by multi-point reception to collect uplink quality measurements of a wireless device from one, or a number of, potential target cells. The solution also includes a mechanism where the serving/source network node requests uplink quality measurement from one, or a number of, potential target cells. For the IAF case this may be done without any impact on the wireless device. For the IEF case the wireless device needs to be informed of which frequency carriers to transmit at least DMRSs on. In an example, the wireless device is thus configured with uplink Carrier Aggregation on the potential target frequencies in order for the potential target IAF cell to measure uplink quality.

When the uplink SINR of both the serving and potential target cells is known the network node is able to take a mobility decision that assures both a good uplink and downlink for the wireless device. The serving and target cells may be compared using the same measure. The network node is then able to trigger handover to the cell of the target network node where best radio conditions are met for the wireless device—considering both uplink and downlink.

FIG. 3c is a flowchart of a method performed by a serving network node for providing mobility to a wireless device according to an exemplifying embodiment. This example is applicable on a communication network based on LTE.

In action 1, a wireless device in RRC_CONNECTED mode in the serving cell needs a better uplink. There might be different reasons such as: the wireless device have moved and the radio coverage in uplink is bad, the load situation might have changed due to e.g. increased interference or noise on the uplink, or the wireless device has been determined to be “uplink heavy” and shall be given highest priority for best uplink.

2. A target cell with better uplink is needed. Potential target cells needs to be determined and the uplink quality measured. The target cells might be a set of cells known to have overlapping coverage with the serving cell (stored in a data base, for example built up by SON functionality). Or the wireless device might have sent a measurement report indicating a better cell (from the downlink perspective) has been found. In case the target cells use the same frequency go to step 4.

3. The wireless device is configured with Carrier Aggregation if this is not already done. One or more secondary cells (SCells) are configured in step one with RRC signalling. The wireless device is then ready to be activated for CA. CA for the SCell(s) are in the next step activated, this may be done by Medium Access Control, MAC, control elements.

4. Scheduling information of the wireless device is determined and sent to the potential target network node(s): start Physical Resource Block, PRB, number of scheduled PRBs, DMRS identities, sub-frame information.

5. Uplink quality measurements are performed in the potential target network node(s). In case of external network node(s) this may require X2/S1 signalling. See also description in FIG. 3d.

6. Received spectral density from the wireless device as well as noise and interference level in the serving and target cell(s) (network nodes) are measured. Uplink SINR in cell of serving network node is calculated and filtered. SINR=S/(N+I). Uplink SINR for the wireless device in the potential target cell is determined or calculated. This may be done either in the potential target network node(s) and sent to the serving network node, alternatively the S and N+I is signalled to the serving network node and the calculation is done there as described above.

7. Mobility evaluation is performed. One or many criteria may be applied. E.g. SINR(target) is compared to an absolute threshold SINR(TargetThres). In case SINR(target)>SINR(TargetThres) the uplink in the target cell is above a basic limit and considered to be good enough. Furthermore the uplink may be SINR(target) may be compared to the SINR(serving). In case SINR(target)>=SINR(source)+Offset the uplink in the cell of the target network node is better than in the cell of the source network node. A combination of uplink and downlink criteria may be applied. I.e. both uplink and downlink may need to be above a basic quality threshold. However it is possible to use only the uplink evaluation.

8. In case the handover criteria are fulfilled for any of the evaluated target network node(s) a handover is triggered. In case none of the evaluated target network node(s) are good enough the procedure may be started again, and other target cells, i.e. other cells of potential target network nodes, may be evaluated.

FIG. 3d is a signalling diagram in an example of uplink quality measurements in a potential target network node. FIG. 3d describes the procedure for performing uplink quality measurements in a potential target cell. This procedure may be done in parallel for any number of target network nodes and for a number of different target frequencies. The procedure has been described in detail above and will not be repeated anew in order to avoid unnecessary repetition.

The uplink quality supervision may be continuously ongoing in a group of cells known to have overlapping radio coverage with the serving cell. When the uplink quality of serving and neighbour cell is known the serving/source network node may consider both the uplink and the downlink when taking the handover decisions. In second variant of the solution, the uplink quality supervision is started upon request from the serving network node at certain coverage events, for example the uplink supervision is started when the uplink quality value in the serving cell is below a threshold or when a wireless device is classified as uplink heavy. In a third variant of the solution, the uplink quality is performed as a check when the wireless device has found a target cell that fulfils the downlink quality thresholds.

The solution described herein by means of the method performed by the source network node and the method performed by the target network node makes it possible to measure and compare the uplink quality between the source cell and one or many potential target cells on the same carrier frequency or on different carrier frequencies.

Knowledge of the uplink on source and target cells is invaluable for the source network node mobility evaluator, i.e. when taking mobility decisions. The source network node mobility evaluator may take both uplink and downlink radio link quality into account when deciding about handovers. In areas with un-coordinated uplink and downlink this may lead to less dropped calls and better throughput.

Embodiments herein also relate to a source network node operable in a wireless communication network serving a wireless device in the wireless communication network for providing mobility to the wireless device. The source network node has the same technical features, objects and advantages as the method performed by the source network node. The source network node will only be described in brief in order to avoid unnecessary repetition.

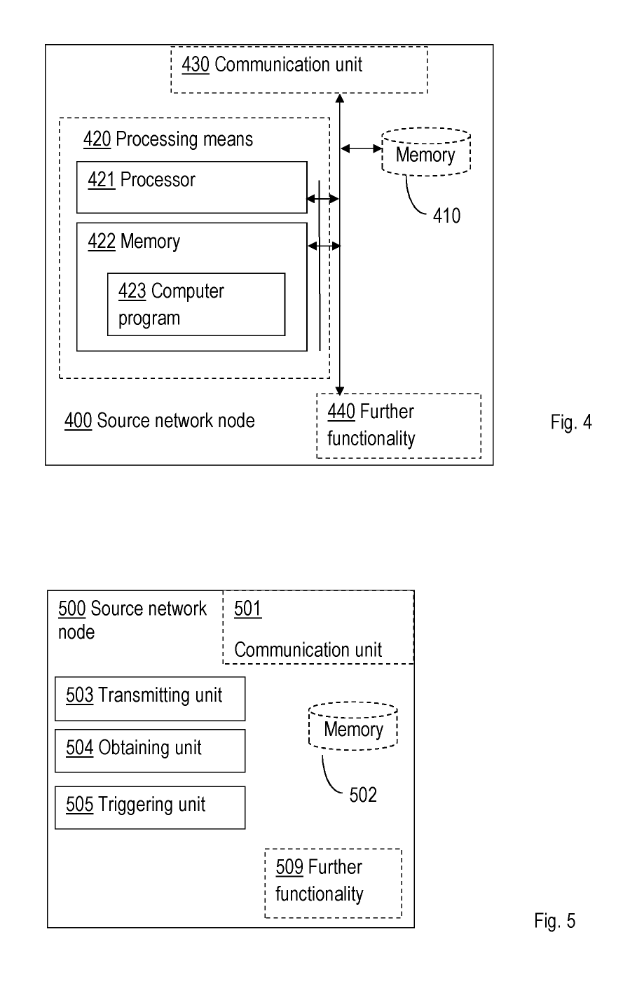

The source network node will be described with reference to FIGS. 4 and 5. Both FIG. 4 and FIG. 5 are block diagram of embodiments of the source network node operable in a wireless communication network serving a wireless device in the wireless communication network for providing mobility to the wireless device.

FIGS. 4 and 5 illustrate the source network node 400, 500 being configured for, when an uplink received signal quality from the wireless device does not meet a quality threshold, transmitting scheduling information related to an upcoming uplink transmission of the wireless device to one or more potential target network nodes. The source network node 400, 500 is further configured for obtaining respective uplink signal quality for the respective potential target network node(s); and for triggering handover to a target network node if a handover criterion is fulfilled based on the respective uplink signal quality.

The source network node 400, 500 may be realised or implemented in various different ways. A first exemplifying implementation or realisation is illustrated in FIG. 4. FIG. 4 illustrates the source network node 400 comprising a processor 421 and memory 422, the memory comprising instructions, e.g. by means of a computer program 423, which when executed by the processor 421 causes the source network node 400 to transmit scheduling information related to an upcoming uplink transmission of the wireless device to one or more potential target network nodes. The memory further comprises instructions, which when executed by the processor 421 causes the source network node 400 to obtain respective uplink signal quality for the respective potential target network node(s); and to trigger handover to a target network node if a handover criterion is fulfilled based on the respective uplink signal quality.

FIG. 4 also illustrates the source network node 400 comprising a memory 410. It shall be pointed out that FIG. 4 is merely an exemplifying illustration and memory 410 may be optional, be a part of the memory 422 or be a further memory of the source network node 400. The memory may for example comprise information relating to the source network node 400, to statistics of operation of the source network node 400, just to give a couple of illustrating examples. FIG. 4 further illustrates the source network node 400 comprising processing means 420, which comprises the memory 422 and the processor 421. Still further, FIG. 4 illustrates the source network node 400 comprising a communication unit 430. The communication unit 430 may comprise an interface through which the source network node 400 communicates with other nodes or entities of the communication network as well as other communication units. FIG. 4 also illustrates the source network node 400 comprising further functionality 440. The further functionality 440 may comprise hardware of software necessary for the source network node 400 to perform different tasks that are not disclosed herein.

An alternative exemplifying implementation of the source network node 400, 500 is illustrated in FIG. 5. FIG. 5 illustrates the source network node 500 comprising a transmitting unit 503 for receiving transmitting scheduling information related to an upcoming uplink transmission of the wireless device to one or more potential target network nodes. The source network node 500 further comprises an obtaining unit 504 for obtaining respective uplink signal quality for the respective potential target network node(s); and a triggering unit 505 for triggering handover to a target network node if a handover criterion is fulfilled based on the respective uplink signal quality.

In FIG. 5, the source network node 500 is also illustrated comprising a communication unit 501. Through this unit, the source network node 500 is adapted to communicate with other nodes and/or entities in the wireless communication network. The communication unit 501 may comprise more than one receiving arrangement. For example, the communication unit 501 may be connected to both a wire and an antenna, by means of which the source network node 500 is enabled to communicate with other nodes and/or entities in the wireless communication network. Similarly, the communication unit 501 may comprise more than one transmitting arrangement, which in turn is connected to both a wire and an antenna, by means of which the source network node 500 is enabled to communicate with other nodes and/or entities in the wireless communication network. The source network node 500 is further illustrated comprising a memory 502 for storing data. Further, the source network node 500 may comprise a control or processing unit (not shown) which in turn is connected to the different units 503-505. It shall be pointed out that this is merely an illustrative example and the source network node 500 may comprise more, less or other units or modules which execute the functions of the source network node 500 in the same manner as the units illustrated in FIG. 5.

It should be noted that FIG. 5 merely illustrates various functional units in the source network node 500 in a logical sense. The functions in practice may be implemented using any suitable software and hardware means/circuits etc. Thus, the embodiments are generally not limited to the shown structures of the source network node 500 and the functional units. Hence, the previously described exemplary embodiments may be realised in many ways. For example, one embodiment includes a computer-readable medium having instructions stored thereon that are executable by the control or processing unit for executing the method steps in the source network node 500. The instructions executable by the computing system and stored on the computer-readable medium perform the method steps of the source network node 500 as set forth in the claims.

The source network node has the same advantages as the method performed by the source network node. One possible advantage is that both the uplink and downlink situation, or characteristics, may be taken into account when determining whether to hand over the wireless device or not. Another possible advantage is that handover oscillations may be prevented since the risk of the uplink being too poor after handover may be minimised or eliminated. Still a possible advantage is that less number of calls may be dropped, again due to minimalizing or eliminating the risk of having a poor uplink after handover. Yet a possible advantage is that a better throughput may be obtained. A further possible advantage is that less handover failures may be achieved.

According to an embodiment, the handover criteria comprises one or more of (i) a relationship between uplink signal quality for the source network node and respective uplink signal quality for the respective potential target network node(s); (ii) relationship between uplink signal quality for the target network node and a target signal quality threshold; and (iii) a relationship between a downlink signal quality for the source network node and respective downlink signal quality for the respective potential target network node(s).

According to yet an embodiment, the signal quality is determined or represented by one or more of SINR, RPSD, RSRQ, RSRP, and RSSI.

According to still an embodiment, the source network node 400, 500 is configured for obtaining the respective signal quality, e.g. SINR, for the respective potential target network node(s) by receiving the respective signal quality, e.g. SINR, from the respective potential target network nodes.

According to another embodiment, the source network node 400, 500 is configured for obtaining the respective signal quality, i.e. SINR, for the respective potential target network node(s) by receiving measured received signal strength and interference plus noise from the respective potential target network node(s) and determining the respective SINR for the respective potential target network node(s) based on the received measured received signal strength and interference plus noise from the respective potential target network nodes.

According to a further embodiment, the source network node 400, 500 is further configured for determining which network node(s) is/are potential target network node(s).

According to yet an embodiment, the source network node 400, 500 is configured for determining of which network node(s) is/are potential target network node(s) by one of (a) obtaining the potential network node(s) from a database or memory, or (b) receiving a measurement report from the wireless device indicating respective signal strength of neighbouring network nodes and determining the potential target network node(s) based on the received measurement report.

According to still an embodiment, the source network node 400, 500 is further configured for transmitting information to the wireless device indicating which frequency carriers to transmit at least DMRSs on.

Embodiments herein also relate to a target network node operable in a wireless communication network for providing mobility to the wireless device. The target network node has the same technical features, objects and advantages as the method performed by the target network node. The target network node will only be described in brief in order to avoid unnecessary repetition.

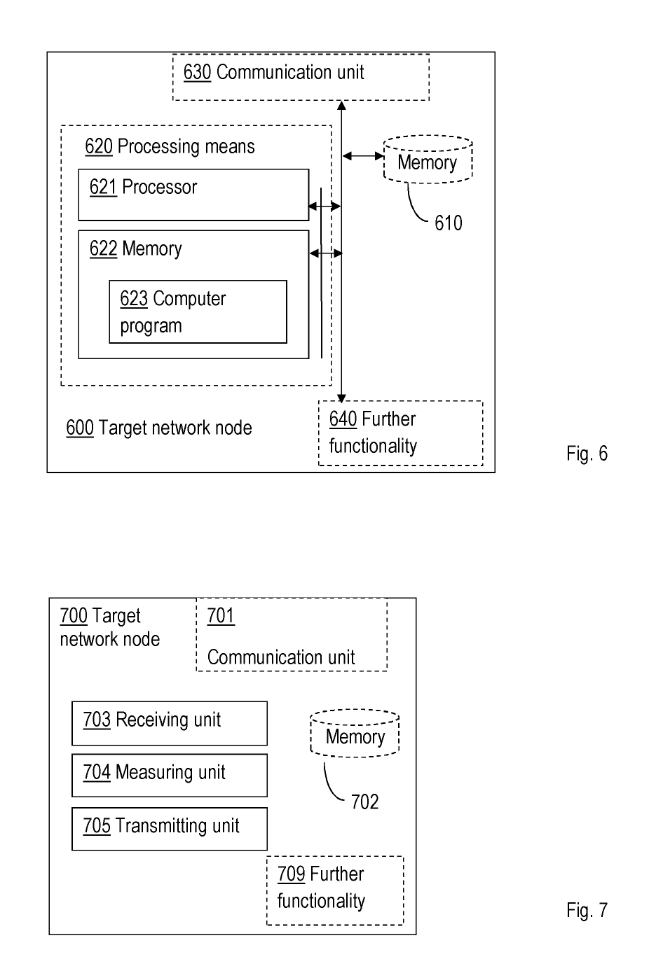

The target network node will be described with reference to FIGS. 6 and 7. Both FIG. 6 and FIG. 7 are block diagram of embodiments of the target network node operable in a wireless communication network for providing mobility to the wireless device.

FIGS. 6 and 7 illustrate the target network node 600, 700 being configured for receiving scheduling information related to an upcoming uplink transmission of the wireless device from source network node; measuring received uplink quality for the scheduled transmission; and transmitting a measurement report to source network node.

The target network node 600, 700 may be realised or implemented in various different ways. A first exemplifying implementation or realisation is illustrated in FIG. 6. FIG. 6 illustrates the target network node 600 comprising a processor 621 and memory 622, the memory comprising instructions, e.g. by means of a computer program 623, which when executed by the processor 621 causes the target network node 600 to receive scheduling information related to an upcoming uplink transmission of the wireless device from source network node; to measure received uplink quality for the scheduled transmission; and to transmit measurement report to source network node.

FIG. 6 also illustrates the target network node 600 comprising a memory 610. It shall be pointed out that FIG. 6 is merely an exemplifying illustration and memory 610 may be optional, be a part of the memory 622 or be a further memory of the target network node 600. The memory may for example comprise information relating to the target network node 600, to statistics of operation of the target network node 600, just to give a couple of illustrating examples. FIG. 6 further illustrates the target network node 600 comprising processing means 620, which comprises the memory 622 and the processor 621. Still further, FIG. 6 illustrates the target network node 600 comprising a communication unit 630. The communication unit 630 may comprise an interface through which the target network node 600 communicates with other nodes or entities of the communication network as well as other communication units. FIG. 6 also illustrates the target network node 600 comprising further functionality 640. The further functionality 640 may comprise hardware of software necessary for the target network node 600 to perform different tasks that are not disclosed herein.

An alternative exemplifying implementation of the target network node 600, 700 is illustrated in FIG. 7. FIG. 7 illustrates the target network node 700 comprising a receiving unit 703 for receiving scheduling information related to an upcoming uplink transmission of the wireless device from source network node. The target network node 600 further comprises a measuring unit 704 for measuring received uplink quality for the scheduled transmission; and a transmitting unit 705 for transmitting a measurement report to source network node.

In FIG. 7, the target network node 700 is also illustrated comprising a communication unit 701. Through this unit, the target network node 700 is adapted to communicate with other nodes and/or entities in the wireless communication network. The communication unit 701 may comprise more than one receiving arrangement. For example, the communication unit 701 may be connected to both a wire and an antenna, by means of which the target network node 700 is enabled to communicate with other nodes and/or entities in the wireless communication network. Similarly, the communication unit 701 may comprise more than one transmitting arrangement, which in turn is connected to both a wire and an antenna, by means of which the target network node 700 is enabled to communicate with other nodes and/or entities in the wireless communication network. The target network node 700 is further illustrated comprising a memory 702 for storing data. Further, the target network node 700 may comprise a control or processing unit (not shown) which in turn is connected to the different units 703-705. It shall be pointed out that this is merely an illustrative example and the target network node 700 may comprise more, less or other units or modules which execute the functions of the target network node 700 in the same manner as the units illustrated in FIG. 7.

It should be noted that FIG. 7 merely illustrates various functional units in the target network node 700 in a logical sense. The functions in practice may be implemented using any suitable software and hardware means/circuits etc. Thus, the embodiments are generally not limited to the shown structures of the target network node 700 and the functional units. Hence, the previously described exemplary embodiments may be realised in many ways. For example, one embodiment includes a computer-readable medium having instructions stored thereon that are executable by the control or processing unit for executing the method steps in the target network node 700. The instructions executable by the computing system and stored on the computer-readable medium perform the method steps of the target network node 700 as set forth in the claims.

The target network node has the same advantages as the method performed by the target network node. One possible advantage is that both the uplink and downlink situation, or characteristics, may be taken into account when determining whether to hand over the wireless device or not. Another possible advantage is that handover oscillations may be prevented since the risk of the uplink being too poor after handover may be minimised or eliminated. Still a possible advantage is that less number of calls may be dropped, again due to minimalizing or eliminating the risk of having a poor uplink after handover. Yet a possible advantage is that a better throughput may be obtained. A further possible advantage is that less handover failures may be achieved.

According to an embodiment, the target network node 700 is further configured for measuring of the received uplink quality for the scheduled transmission by receiving the uplink transmission from the wireless device.

According to yet an embodiment, the measurement report comprises (i) an uplink Signal to Noise and Interference, SINR, which is determined based on the measuring of the received uplink quality for the scheduled transmission; or (ii) a measured received signal strength and noise plus interference of the target network node.

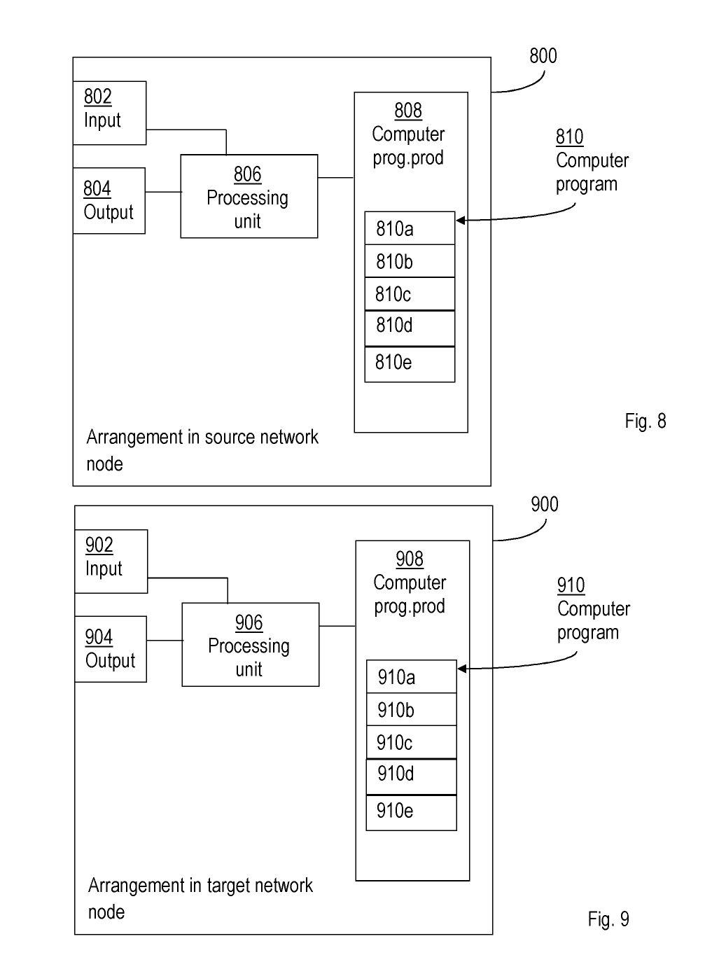

FIG. 8 schematically shows an embodiment of an arrangement 800 in a source network node 500. Comprised in the arrangement 800 in the source network node 500 are here a processing unit 806, e.g. with a Digital Signal Processor, DSP. The processing unit 806 may be a single unit or a plurality of units to perform different actions of procedures described herein. The arrangement 800 of the source network node 500 may also comprise an input unit 802 for receiving signals from other entities, and an output unit 804 for providing signal(s) to other entities. The input unit and the output unit may be arranged as an integrated entity or as illustrated in the example of FIG. 5, as one or more interfaces 501.

Furthermore, the arrangement 800 in the source network node 500 comprises at least one computer program product 808 in the form of a non-volatile memory, e.g. an Electrically Erasable Programmable Read-Only Memory, EEPROM, a flash memory and a hard drive. The computer program product 808 comprises a computer program 810, which comprises code means, which when executed in the processing unit 806 in the arrangement 800 in the source network node 500 causes the source network node 500 to perform the actions e.g. of the procedure described earlier in conjunction with FIGS. 1a-1c.

The computer program 810 may be configured as a computer program code structured in computer program modules 810a-810e. Hence, in an exemplifying embodiment, the code means in the computer program of the arrangement 800 in the source network node 500 comprises a transmitting unit, or module, for, transmitting scheduling information related to an upcoming uplink transmission of the wireless device to one or more potential target network nodes when an uplink received signal quality from the wireless device does not meet a quality threshold; and an obtaining unit, or module, for obtaining respective uplink signal quality for the respective potential target network node(s). The computer program further comprises a triggering unit, or module, for triggering handover to a target network node if a handover criterion is fulfilled based on the respective uplink signal quality.

The computer program modules could essentially perform the actions of the flow illustrated in FIGS. 1a-1c, to emulate the target network node 500. In other words, when the different computer program modules are executed in the processing unit 806, they may correspond to the units 503-505 of FIG. 5.

FIG. 9 schematically shows an embodiment of an arrangement 900 in a target network node 700. Comprised in the arrangement 900 in the target network node 700 are here a processing unit 906, e.g. with DSP. The processing unit 906 may be a single unit or a plurality of units to perform different actions of procedures described herein. The arrangement 900 of the target network node 700 may also comprise an input unit 902 for receiving signals from other entities, and an output unit 904 for providing signal(s) to other entities. The input unit and the output unit may be arranged as an integrated entity or as illustrated in the example of FIG. 7, as one or more interfaces 701.

Furthermore, the arrangement 900 in the target network node 700 comprises at least one computer program product 908 in the form of a non-volatile memory, e.g. an EEPROM, a flash memory and a hard drive. The computer program product 908 comprises a computer program 910, which comprises code means, which when executed in the processing unit 906 in the arrangement 900 in the target network node 700 causes the target network node 700 to perform the actions e.g. of the procedure described earlier in conjunction with FIG. 2.

The computer program 910 may be configured as a computer program code structured in computer program modules 910a-910e. Hence, in an exemplifying embodiment, the code means in the computer program of the arrangement 900 in the target network node 700 comprises a receiving unit, or module, for receiving scheduling information related to an upcoming uplink transmission of the wireless device from a source network node; and a measuring unit for measuring received uplink quality for the scheduled transmission. The computer program further comprises a transmitting unit, or module, for transmitting a measurement report to the source network node.

The computer program modules could essentially perform the actions of the flow illustrated in FIG. 2, to emulate the target network node 700. In other words, when the different computer program modules are executed in the processing unit 906, they may correspond to the units 703-705 of FIG. 7.

Although the code means in the embodiments disclosed above in conjunction with FIGS. 5 and 7 are implemented as computer program modules which when executed in the respective processing unit causes the source network node and the target network node to perform the actions described above in the conjunction with figures mentioned above, at least one of the code means may in alternative embodiments be implemented at least partly as hardware circuits.

The processor may be a single Central Processing Unit, CPU, but could also comprise two or more processing units. For example, the processor may include general purpose microprocessors; instruction set processors and/or related chips sets and/or special purpose microprocessors such as Application Specific Integrated Circuits, ASICs. The processor may also comprise board memory for caching purposes. The computer program may be carried by a computer program product connected to the processor. The computer program product may comprise a computer readable medium on which the computer program is stored. For example, the computer program product may be a flash memory, a Random-Access Memory RAM, Read-Only Memory, ROM, or an EEPROM, and the computer program modules described above could in alternative embodiments be distributed on different computer program products in the form of memories within the source network node and the target network node respectively.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method performed by a source network node serving a wireless device in a wireless communication network for providing mobility to the wireless device, the method comprising, when an uplink received signal quality from the wireless device does not meet a quality threshold:
transmitting scheduling information related to an upcoming uplink transmission of the wireless device to one or more potential target network nodes,
obtaining respective uplink signal quality for the respective potential target network node(s), and
triggering handover to a target network node if a handover criterion is fulfilled based on the respective uplink signal quality.

2. A method according to claim 1, wherein the handover criteria comprises one or more of (i) a relationship between uplink signal quality for the source network node and respective uplink signal quality for the respective potential target network node(s); (ii) relationship between uplink signal quality for the target network node and a target signal quality threshold; and (iii) a relationship between a downlink signal quality for the source network node and respective downlink signal quality for the respective potential target network node(s).

3. A method according to claim 1, wherein the signal quality is determined or represented by one or more of Signal to Interference and Noise Ratio, SINR, Received Power Spectral Density, RPSD, Reference Signal Received Quality, RSRQ, Reference Signal Received Power, RSRP, and Received Signal Strength Indicator, RSSI.

4. A method according to claim 1, wherein the obtaining of the respective signal quality, e.g. SINR, for the respective potential target network node(s) comprises receiving the respective signal quality, e.g. SINR, from the respective potential target network nodes.

5. A method according to claim 1, wherein the obtaining of the respective signal quality, i.e. SINR, for the respective potential target network node(s) comprises receiving measured received signal strength and interference plus noise from the respective potential target network node(s) and determining the respective SINR for the respective potential target network node(s) based on the received measured received signal strength and interference plus noise from the respective potential target network nodes.

6. A method according to claim 1, further comprising determining which network node(s) is/are potential target network node(s).

7. A method according to claim 6, wherein the determining of which network node(s) is/are potential target network node(s) comprises one of (a) obtaining the potential network node(s) from a database or memory, (b) or receiving a measurement report from the wireless device indicating respective signal strength of neighbouring network nodes and determining the potential target network node(s) based on the received measurement report.

8. A method according to claim 1, further comprising transmitting information to the wireless device indicating which frequency carriers to transmit at least DeModulation References Signals, DMRSs, on.

9. A method performed by a target network node for providing mobility to the wireless device, the method comprising:
receiving scheduling information related to an upcoming uplink transmission of the wireless device from source network node,
measuring received uplink quality for the scheduled transmission, and
transmitting a measurement report to source network node.

10. A method according to claim 9, wherein the measuring of the received uplink quality for the scheduled transmission comprises receiving the uplink transmission from the wireless device.

11. A method according to claim 9, wherein the measurement report comprises (i) an uplink Signal to Noise and Interference, SINR, which is determined based on the measuring of the received uplink quality for the scheduled transmission; or (ii) a measured received signal strength and noise plus interference of the target network node.

12. A source network node operable in a wireless communication network serving a wireless device in the wireless communication network for providing mobility to the wireless device, the source network node being configured for, when an uplink received signal quality from the wireless device does not meet a quality threshold:
transmitting scheduling information related to an upcoming uplink transmission of the wireless device to one or more potential target network nodes,
obtaining respective uplink signal quality for the respective potential target network node(s), and
triggering handover to a target network node if a handover criterion is fulfilled based on the respective uplink signal quality.

13. The source network node according to claim 12, wherein the handover criteria comprises one or more of (i) a relationship between uplink signal quality for the source network node and respective uplink signal quality for the respective potential target network node(s); (ii) relationship between uplink signal quality for the target network node and a target signal quality threshold; and (iii) a relationship between a downlink signal quality for the source network node and respective downlink signal quality for the respective potential target network node(s).

14. The source network node according to claim 12, wherein the signal quality is determined or represented by one or more of Signal to Interference and Noise Ratio, SINR, Received Power Spectral Density, RPSD, Reference Signal Received Quality, RSRQ, Reference Signal Received Power, RSRP, and Received Signal Strength Indicator, RSSI.

15. The source network node according to claim 12, wherein the source network node is configured for obtaining the respective signal quality, e.g. SINR, for the respective potential target network node(s) by receiving the respective signal quality, e.g. SINR, from the respective potential target network nodes.

16. The source network node according to claim 12, wherein the source network node is configured for obtaining the respective signal quality, i.e. SINR, for the respective potential target network node(s) by receiving measured received signal strength and interference plus noise from the respective potential target network node(s) and determining the respective SINR for the respective potential target network node(s) based on the received measured received signal strength and interference plus noise from the respective potential target network nodes.

17. The source network node according to claim 12, further being configured for determining which network node(s) is/are potential target network node(s).

18. The source network node according to claim 17, wherein the source network node is configured for determining of which network node(s) is/are potential target network node(s) by one of (a) obtaining the potential network node(s) from a database or memory, or (b) receiving a measurement report from the wireless device indicating respective signal strength of neighbouring network nodes and determining the potential target network node(s) based on the received measurement report.

19. The source network node according to claim 12, further being configured for transmitting information to the wireless device indicating which frequency carriers to transmit at least DeModulation References Signals, DMRSs, on.

20. A target network node operable in a wireless communication network for providing mobility to the wireless device, the target network node being configured for:
receiving scheduling information related to an upcoming uplink transmission of the wireless device from source network node,
measuring received uplink quality for the scheduled transmission, and
transmitting measurement report to source network node.

21. The target network node according to claim 20, being configured for measuring of the received uplink quality for the scheduled transmission by receiving the uplink transmission from the wireless device.

22. The target network node according to claim 20, wherein the measurement report comprises (i) an uplink Signal to Noise and Interference, SINR, which is determined based on the measuring of the received uplink quality for the scheduled transmission; or (ii) a measured received signal strength and noise plus interference of the target network node.

23-26. (canceled)
